(19) United States
(12) Patent Application Publication
(10) Pub. No.: US 2026/0204502 A1
(43) Pub. Date: Jul. 16, 2026

(54) RELAY

(71) Applicant: Xiamen Hongfa Electric Power Controls Co., Ltd., Xiamen, Fujian (CN)

(72) Inventors: Zhongbo HE, Xiamen, Fujian (CN); Shuming ZHONG, Xiamen, Fujian (CN); Wenguang DAI, Xiamen, Fujian (CN); Feng HE, Xiamen, Fujian (CN); Liji SU, Xiamen, Fujian (CN); Kunming SHEN, Xiamen, Fujian (CN)

(21) Appl. No.: 19/134,694

(22) PCT Filed: Nov. 30, 2023
(86) PCT No.: PCT/CN2023/135573

§ 371 Date: May 30, 2025

(30) Foreign Application Priority Data
Dec. 1, 2022 (CN) 202211543693.X

(51) Int. Cl. H01H 50/04; H01H 50/16; H01H 50/64

(52) U.S. Cl. CPC H01H 50/04; H01H 50/16; H01H 50/641

(57) ABSTRACT

A relay includes a housing provided with a mounting part; at least one contact assembly, with each including a static contact piece and a movable contact piece; a push rod mechanism movable relative to the housing along a contact-separation direction of contacts of the contact assembly, wherein the movable contact piece is disposed on the push rod mechanism, and the push rod mechanism drives the movable contact piece to move, and wherein the mounting part is located at a side of the push rod mechanism in a radial direction, and the radial direction is perpendicular to a movement direction of the push rod mechanism; and at least one first magnetizer in one-to-one correspondence with at least one movable contact piece, the first magnetizer is fixedly connected to the mounting part and located at a side of the movable contact piece facing corresponding static contact piece.

### CROSS-REFERENCE

The present disclosure is the U.S. national phase application of International Application No. PCT/CN2023/135573, filed on Nov. 30, 2023, which claims priority to Chinese Patent Application No. 202211543693.X, filed on Dec. 1, 2022, the entire content of which is incorporated herein by reference in its entirety.

### TECHNICAL FIELD

The present disclosure relates to the technical field of electronic control devices and, more particularly, to a relay.

### BACKGROUND

A relay is an electronic control device that has a control system (also known as an input circuit) and a controlled system (also known as an output circuit) and is typically used in an automatic control circuit. In fact, the relay is an “automatic switch” that uses a small current to control a large current, and hence plays a role in automatic regulation, safety protection and circuit conversion.

Under a large short-circuit load, contacts of the relay may pop open due to an electro-dynamic repulsion force generated by a short-circuit current, and the instant pop-open of the contacts may cause the relay to burn or explode under action of a strong arc.

In the related art, the relay is usually provided with an anti-short circuit structure to prevent the contacts from popping open. Specifically, a magnetizer is mounted inside the relay, and the magnetizer is magnetized under action of the short-circuit current to form a closed-loop magnetic field and generate an electromagnetic attraction force, thereby preventing the contacts from instantly popping open due to the repulsion force generated by the short-circuit current, and avoiding burnout and explosion of the relay.

However, the fixed arrangement of the magnetizer in the related art may only adapt to a single set of movable and static contacts, and cannot meet an anti-short circuit requirement of two or more sets of movable and static contacts.

### SUMMARY

A relay according to embodiments of the present disclosure includes a housing, at least one contact assembly, a push rod mechanism, and at least one first magnetizer. The housing is provided with a mounting part. Each contact assembly includes a static contact piece and a movable contact piece, the static contact piece being fixedly connected to the housing, and the movable contact piece being disposed within the housing. The movable contact piece is disposed within the housing. The push rod mechanism is movable relative to the housing along a contact-separation direction of contacts of the contact assembly; the movable contact piece is disposed on the push rod mechanism, and the push rod mechanism is configured to drive the movable contact piece to move, to allow the movable contact piece to contact with or separate from corresponding static contact piece; the mounting part is located at a side of the push rod mechanism in a radial direction, and the radial direction is perpendicular to a movement direction of the push rod mechanism. The at least one first magnetizer is in one-to-one correspondence with at least one movable contact piece of the at least one contact assembly, the first magnetizer being fixedly connected to the mounting part and located at a side of the movable contact piece facing corresponding static contact piece.

In some embodiments of the present disclosure, the housing includes a side wall located at the side of the push rod mechanism in the radial direction, and the mounting part is formed on the side wall.

In some embodiments of the present disclosure, the side wall surrounds the push rod mechanism along a peripheral direction of the push rod mechanism.

In some embodiments of the present disclosure, the housing includes: a base; and an outer cover connected to the base; the outer cover and the base form a chamber for accommodating the contact assembly, the push rod mechanism, and the first magnetizer; the base and/or the outer cover form the side wall.

In some embodiments of the present disclosure, the first magnetizer includes a connection portion and an overhang portion, and the connection portion is fixedly connected to the mounting part; a virtual plane perpendicular to the movement direction of the push rod mechanism is defined, the connection portion has a first orthographic projection on the virtual plane, the overhang portion has a second orthographic projection on the virtual plane, the movable contact piece has a third orthographic projection on the virtual plane, the first orthographic projection does not overlap with the third orthographic projection, and the second orthographic projection at least partially overlaps with the third orthographic projection.

In some embodiments of the present disclosure, the first magnetizer is of a flat plate structure.

In some embodiments of the present disclosure, the first magnetizer is inserted into the mounting part of the housing along an insertion direction perpendicular to the movement direction of the push rod mechanism.

In some embodiments of the present disclosure, the mounting part includes a first mounting hole penetrating an inner surface and an outer surface of the housing, and a hole wall of the first mounting hole having a first positioning wall structure and a first gap wall structure; the first magnetizer is inserted into the first mounting hole, and a part of an outer wall surface of the first magnetizer abuts against the first positioning wall structure; a gap is formed between a part of the outer wall surface of the first magnetizer and the first gap wall structure, and the gap is filled with a sealant.

In some embodiments of the present disclosure, a part of the outer wall surface of the first magnetizer is in interference fit with the first positioning wall structure.

In some embodiments of the present disclosure, the first positioning wall structure includes a first positioning wall and a second positioning wall, and the first positioning wall and the second positioning wall are disposed opposite to each other along the movement direction of the push rod mechanism.

In some embodiments of the present disclosure, the insertion direction of the first magnetizer is perpendicular to a length direction of the movable contact piece.

In some embodiments of the present disclosure, the static contact piece is inserted into the housing along the insertion direction.

In some embodiments of the present disclosure, the housing further has a second mounting hole penetrating an inner surface and an outer surface of the housing, and a hole wall of the second mounting hole has a second positioning wall structure and a second gap wall structure; the static contact piece is inserted into the second mounting hole, and a part of an outer wall surface of the static contact piece abuts against the second positioning wall structure; a gap is formed between the outer wall surface of the static contact piece and the second gap wall structure, and the gap is filled with a sealant.

In some embodiments of the present disclosure, a part of the outer wall surface of the static contact piece is in interference fit with the second positioning wall structure.

In some embodiments of the present disclosure, the second positioning wall structure includes a third positioning wall and a fourth positioning wall, and the third positioning wall and the fourth positioning wall are disposed opposite to each other along the movement direction of the push rod mechanism.

In some embodiments of the present disclosure, the relay further includes at least one second magnetizer; the at least one second magnetizer corresponds to the at least one first magnetizer; the second magnetizer is fixedly connected to a side of the movable contact piece facing away from the first magnetizer, to form a magnetic circuit between the first magnetizer and corresponding second magnetizer and in a width direction of the movable contact piece.

In some embodiments of the present disclosure, the second magnetizer is U-shaped and wraps around the movable contact piece along the width direction of the movable contact piece.

In some embodiments of the present disclosure, the second magnetizer includes at least two sub-magnetizers, each of which is U-shaped; the movable contact piece is provided with at least one through hole; the at least two sub-magnetizers are connected to the side of the movable contact piece facing away from the first magnetizer, and side portions of the at least two sub-magnetizers pass through at least one through hole, to approach or contact the first magnetizer through the through hole and form at least two independent magnetic circuits in the width direction of the movable contact piece.

In some embodiments of the present disclosure, a gap is formed between two side portions located in one through hole.

### BRIEF DESCRIPTION OF THE DRAWINGS

The above and other features and advantages of the present disclosure will become more apparent by describing in detail exemplary embodiments with reference to the accompanying drawings.

FIG. 1 shows a top view of a relay according to embodiments of the present disclosure, with a housing omitted.

FIG. 2 shows a sectional view taken along line A-A in FIG. 1.

FIG. 3 shows a sectional view taken along line B-B in FIG. 2.

FIG. 4 shows a schematic view of relative positions of a first orthographic projection, a second orthographic projection, and a third orthographic projection on a virtual plane.

FIG. 5 shows a sectional view taken along line C-C in FIG. 2.

FIG. 6 shows a partially enlarged view of X1 in FIG. 5.

FIG. 7 shows a partially enlarged view of X2 in FIG. 5.

FIG. 8 shows a schematic view after a push rod, a yoke plate, a first magnetizer, a second magnetizer, and a contact assembly are assembled according to a first embodiment of the present disclosure.

FIG. 9 shows a schematic view after the first magnetizer, the second magnetizer, and the contact assembly are assembled according to the first embodiment of the present disclosure.

FIGS. 10 and 11 respectively show schematic views from two different perspectives after a movable contact piece and a second magnetizer are assembled according to a second embodiment of the present disclosure.

FIGS. 12 and 13 respectively show schematic views from two different perspectives after a movable contact piece, a first magnetizer, and a second magnetizer are assembled according to a third embodiment of the present disclosure.

FIG. 14 shows a sectional view of D-D in FIG. 13.

FIGS. 15 and 16 respectively show schematic views from two different perspectives after a movable contact piece, a first magnetizer, and a second magnetizer are assembled according to a fourth embodiment of the present disclosure.

FIG. 17 shows a sectional view of E-E in FIG. 16.

FIGS. 18 and 19 respectively show schematic views from two different perspectives after a movable contact piece, a first magnetizer, and a second magnetizer are assembled according to a fifth embodiment of the present disclosure.

FIG. 20 shows a sectional view of F-F in FIG. 19.

FIGS. 21 and 22 respectively show schematic views from two different perspectives after a movable contact piece, a first magnetizer, and a second magnetizer are assembled according to a sixth embodiment of the present disclosure.

FIG. 23 shows a sectional view of G-G in FIG. 22.

FIGS. 24 and 25 respectively show schematic views from two different perspectives after a movable contact piece, a first magnetizer, and a second magnetizer are assembled according to a seventh embodiment of the present disclosure.

FIG. 26 shows a sectional view of H-H in FIG. 25.

### REFERENCE NUMERALS

1. housing; 11. mounting part; 10. base; 110. first mounting hole; 111. first positioning wall structure; 112. first gap wall structure; 113. first positioning wall; 114. second positioning wall; 120. second mounting hole; 121. second positioning wall structure; 122. second gap wall structure; 123. third positioning wall; 124. fourth positioning wall; 130. bottom plate; 140. side plate; 20. push rod mechanism; 210. push rod; 220. iron core; 30. magnetic circuit mechanism; 310. yoke structure; 311. yoke plate; 3111. through-hole; 312. U-shaped yoke; 320. bobbin; 321. central hole; 330. coil; 340. permanent magnet; 40. contact assembly; 40a. first contact assembly; 40b. second contact assembly; 410. first movable contact piece; 411. first movable contact; 412. first movable piece body; 414. through hole; 420. first static contact piece; 421. first static piece body; 422. first static contact; 430. second movable contact piece; 431. second movable contact; 434. second movable piece body; 440. second static contact piece; 441. second static piece body; 442. second static contact; 610. first magnetizer; 611. connection portion; 612. overhang portion; 613. first short edge; 620. second magnetizer; 621. sub-magnetizer; 622. base portion; 623. side portion; 624. middle protrusion; 625. second short side; P. virtual plane; D1. length direction; D2. width direction; D3. movement direction; D4. insertion direction; S1. first orthographic projection; S2. second orthographic projection; S3. third orthographic projection.

### DETAILED DESCRIPTION

Exemplary embodiments will now be described more comprehensively with reference to the accompanying drawings. However, the exemplary embodiments may be implemented in various forms and should not be understood as being limited to implementations described herein; instead, these embodiments are provided so that the present disclosure will be comprehensive and complete, and the concept of the exemplary embodiments will be fully conveyed to those skilled in the art. The same reference numerals in the drawings denote the same or similar structures, and thus their detailed description will be omitted.

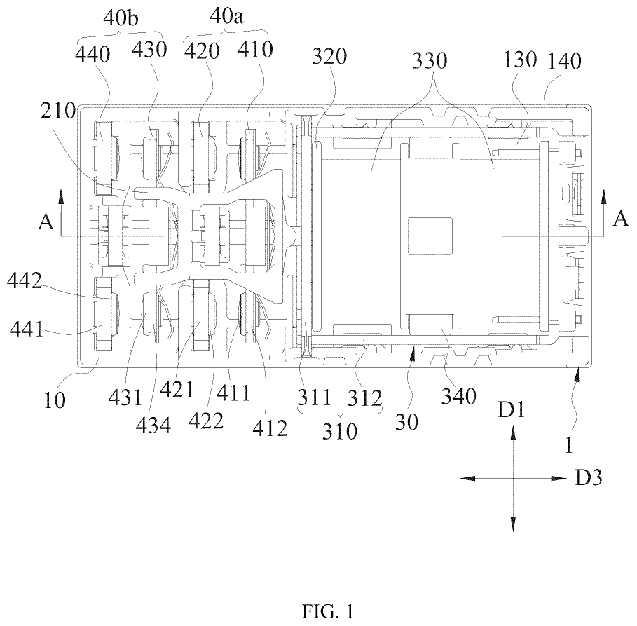

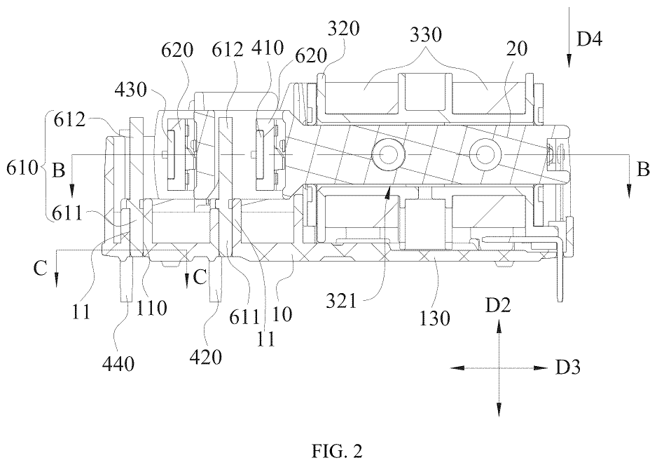

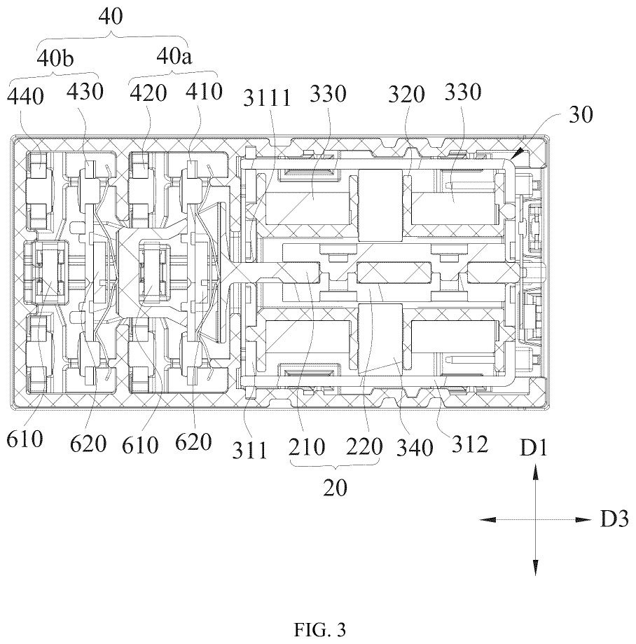

As shown in FIGS. 1 to 3, FIG. 1 shows a top view of a relay according to embodiments of the present disclosure, with a housing omitted; FIG. 2 shows a sectional view taken along line A-A in FIG. 1; and FIG. 3 shows a sectional view taken along line B-B in FIG. 2. The relay according to embodiments of the present disclosure includes a housing 1, a push rod mechanism 20, a magnetic circuit mechanism 30, and a contact assembly 40. In the embodiments of the present disclosure, the housing 1 is an outer shell of the relay. The push rod mechanism 20, the magnetic circuit mechanism 30, and the contact assembly 40 are disposed inside the housing 1. The magnetic circuit mechanism 30 controls contact or separation of contacts of the contact assembly 40 by the push rod mechanism 20.

It can be understood that terms “including” and “having” as well as any variations thereof in embodiments of the present disclosure are intended to cover non-exclusive inclusions. For example, a process, method, system, product, or device that includes a series of steps or units is not limited to the listed steps or units, but may optionally include steps or units that are not listed, or may optionally include other steps or components inherent to these processes, methods, products, or devices.

The housing 1 may include a base 10 and an outer cover (not shown in the drawings), and the outer cover is connected to the base 10 to form a chamber for accommodating the push rod mechanism 20, the magnetic circuit mechanism 30, and the contact assembly 40.

The magnetic circuit mechanism 30 includes a yoke structure 310, a bobbin 320, and a coil 330. The yoke structure 310 forms a chamber, and the bobbin 320 and the coil 330 are both disposed within the chamber of the yoke structure 310. The coil 330 is wound around a periphery of the bobbin 320 to form a magnetic control circuit. The bobbin 320 is provided with a central hole 321 in a contact-separation direction of contacts of the contact assembly 40, and the central hole 321 is used for an end of the push rod mechanism 20 to pass through.

As an example, the yoke structure 310 includes a yoke plate 311 and a U-shaped yoke 312, and the yoke plate 311 and the U-shaped yoke 312 are connected together to form a ring shape. The yoke plate 311 is provided with a through-hole 3111, and the through-hole 3111 is used for the push rod mechanism 20 to pass through.

Certainly, in other embodiments, the yoke structure 310 may also include a cylindrical yoke and a yoke plate 311, which are connected together to form a ring shape.

The magnetic circuit mechanism 30 also includes two permanent magnets 340 disposed on the bobbin 320 and located at both sides of a movement direction D3 of the push rod mechanism 20. Two permanent magnets 340 form a magnetic circuit structure for magnetic latching, which is conducive to reducing electricity costs, extending service life, and improving stability.

Certainly, in other embodiments, it is also possible to not include any permanent magnet 340.

As shown in FIG. 3, the push rod mechanism 20 is movable relative to the base 10 along the contact-separation direction of contacts of the contact assembly 40. The push rod mechanism 20 includes a push rod 210 and an iron core 220 connected to the push rod 210. Under the action of the magnetic control circuit formed by the coil 330, the iron core 220 may move in the contact-separation direction of the contacts, thereby driving the push rod 210 to move, in order to control the contact or separation of contacts of the contact assembly 40.

Still referring to FIGS. 1 to 3, the contact assembly 40 includes a movable contact piece (410, 430) and a static contact piece (420, 440). The static contact piece (420, 440) is fixedly mounted on the base 10, and the movable contact piece (410, 430) is located inside the housing 1. The movable contact piece (410, 430) is mounted on the push rod mechanism 20 and moves along with the push rod mechanism 20.

It should be understood that the movable contacts 410, 430 and the push rod 210 are not limited to the above assembly design, which will not be repeated here.

In this embodiment, there are two contact assemblies 40, namely, a first contact assembly 40a and a second contact assembly 40b, which are disposed along the movement direction D3 of the push rod mechanism 20. Moreover, the first contact assembly 40a is close to the magnetic circuit mechanism 30, while the second contact assembly 40b is away from the magnetic circuit mechanism 30.

The first contact assembly 40a includes a first movable contact piece 410 and two first static contact pieces 420. The second contact assembly 40b includes a second movable contact piece 430 and two second static contact pieces 440. Two ends of the first movable contact piece 410 may be in contact with or separated from the two first static contact pieces 420, and two ends of the second movable contact piece 430 may be in contact or separated from the two second static contact pieces 440.

Certainly, in other embodiments, the contact assembly 40 may be provided in one set or in other quantities.

Two ends of the movable contact piece (410, 430) in a length direction D1 serve as movable contacts, which may protrude from other parts of the movable contact piece (410, 430) or be flush with other parts. A part of the static contact piece (420, 440) in contact with the movable contact serves as a static contact, which may protrude from other parts of the static contact piece (420, 440) or be flush with other parts.

As an example, as shown in FIG. 1, the first movable contact piece 410 includes a first movable piece body 412 and a first movable contact 411. The first movable contact 411 and the first movable piece body 412 are of a separate structure, and the first movable contact 411 and the first movable piece body 412 may be connected by riveting, but not limited thereto. The first static contact piece 420 includes a first static piece body 421 and a first static contact 422. The first static contact 422 and the first static piece body 421 are of a separate structure, and the first static contact 422 and the first static piece body 421 may be connected by riveting, but not limited thereto.

The second movable contact piece 430 includes a second movable piece body 434 and a second movable contact 431. The second movable contact 431 and the second movable piece body 434 are of a separate structure, and the second movable contact 431 and the second movable piece body 434 may be connected by riveting, but not limited thereto. The second static contact piece 440 includes a second static piece body 441 and a second static contact 442. The second static contact 442 and the second static piece body 441 are of a separate structure, and the second static contact 442 and the second static piece body 441 may be connected by riveting, but not limited thereto.

Certainly, in another embodiment, the first movable contact 411 and the first movable piece body 412 may be of an integrated structure; the first static contact 422 and the first static piece body 421 may be of an integrated structure; the second movable contact 431 and the second movable piece body 434 may be of an integrated structure; the second static contact 442 and the second static piece body 441 may be of an integrated structure.

It can be understood that in other embodiments, the housing 1 may also be a ceramic cover.

As shown in FIG. 2, the housing 1 is provided with a mounting part 11, and the mounting part 11 is located at a side of the push rod mechanism 20 in a radial direction, the radial direction being perpendicular to the movement direction D3 of the push rod mechanism 20. The relay according to embodiments of the present disclosure further includes at least one first magnetizer 610 that corresponds to a movable contact piece of at least one contact assembly 40, i.e., located at a side of at least one movable contact piece facing a corresponding static contact piece, respectively. The first magnetizer 610 is fixedly connected to the mounting part 11.

At least one first magnetizer 610 corresponds to at least one contact assembly 40, which means that the number of first magnetizers 610 corresponds to the number of contact assemblies 40, and the positions of the first magnetizers 610 correspond to the positions of the contact assemblies 40. In this embodiment, the number of contact assemblies 40 is two, so the number of first magnetizers 610 is also two, and one of the first magnetizers 610 corresponds to the first movable contact piece 410 of the first contact assembly 40a, while the other of the first magnetizers 610 corresponds to the second movable contact piece 430 of the second contact assembly 40b.

It can be understood that for the relay according to embodiments of the present disclosure, since the mounting part 11 on the housing 1 is located at one side of the push rod mechanism 20 in the radial direction that is perpendicular to the movement direction of the push rod mechanism 20, a position where the first magnetizer 610 is fixedly connected to the mounting part 11 is also located at one side of the push rod mechanism 20, that is, the position where the first magnetizer 610 is connected to the mounting part 11 of the housing 1 is not above the movable contact piece, so that each first magnetizer 610 will not affect movement of the push rod mechanism 20 in case that the relay is provided with a plurality of first magnetizers 610. Therefore, the plurality of contact assemblies 40 in the relay according to embodiments of the present disclosure are correspondingly provided with the plurality of first magnetizers 610, which realizes that each contact assembly 40 is provided with an anti-short circuit structure.

The housing 1 includes a top wall, a bottom wall, and a side wall. The top wall and the bottom wall are opposite to each other along the movement direction of the push rod mechanism 20, and the side wall is connected to the top wall and the bottom wall. The side wall is at one side of the push rod mechanism 20 in the radial direction, and the mounting part 11 is formed on the side wall.

Further, the side wall surrounds the push rod mechanism 20 along a peripheral direction of the push rod mechanism 20.

It can be understood that the shape of the housing 1 may include various embodiments, e.g., the housing 1 may be prismatic, cylindrical, etc., but is not limited thereto.

The base 10 and/or the outer cover of the housing 1 are provided with the mounting part(s) 11. Specifically, the mounting part 11 may be formed only on the base 10, or the mounting part 11 may be formed only on the outer cover. Certainly, the base 10 and the outer cover may both have mounting parts 11 formed on them.

As shown in FIG. 1, the base 10 includes a bottom plate 130 and a side plate 140. The static contact piece is fixedly connected to the bottom plate 130. The side plate 140 is connected to the bottom plate 130 and located at one side of the push rod mechanism 20 in the radial direction. In case that the mounting part 11 is formed on the base 10, the bottom plate 130 and/or the side plate 140 of the base 10 are provided with the mounting part(s) 11. Specifically, the bottom plate 130 may be formed with the mounting part 11; the side plate 140 may be formed with the mounting part 11; or both the bottom plate 130 and the side plate 140 may be formed with the mounting part(s) 11.

It can be understood that in the embodiments of the present disclosure, the bottom plate 130 is defined as a part of the base 10 facing a circuit board when the relay is mounted on the circuit board.

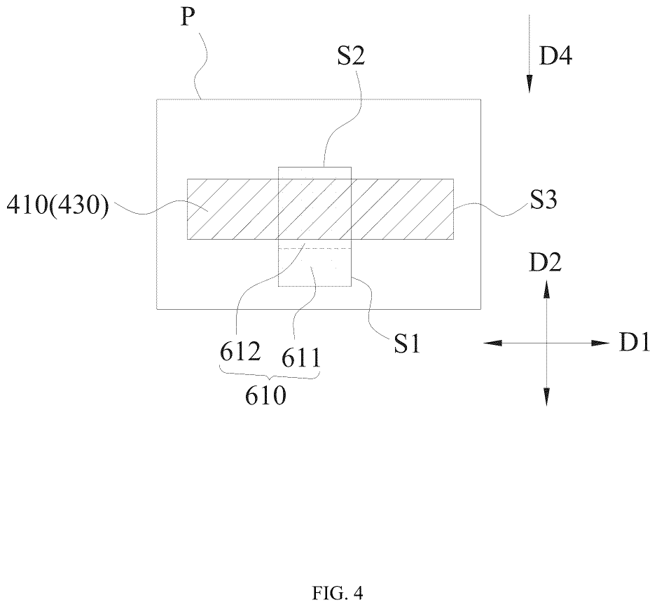

As shown in FIG. 4, it illustrates a schematic view of relative positions of a first orthographic projection S1, a second orthographic projection S2, and a third orthographic projection S3 on a virtual plane P. Each first magnetizer 610 includes a connection portion 611 and an overhang portion 612, and the connection portion 611 is fixedly connected to the mounting part 11 of the base 10. A virtual plane P perpendicular to the movement direction D3 of the push rod mechanism 20 is defined. The connection portion 611 has a first orthographic projection S1 on the virtual plane P, the overhang portion 612 has a second orthographic projection S2 on the virtual plane P, and the movable contact piece (410, 430) has a third orthographic projection S3 on the virtual plane P. The first orthographic projection S1 does not overlap with the third orthographic projection S3, and the second orthographic projection S2 at least partially overlaps with the third orthographic projection S3.

The overhang portion 612 refers to a part of the first magnetizer 610 overhanging within the relay and not in contact with any component of the relay.

It can be understood that for the relay according to embodiments of the present disclosure, the first magnetizer 610 is disposed above the movable contact piece (410, 430); in case that the movable contact piece (410, 430) comes into contact with the static contact piece (420, 440), current flows through the movable contact piece (410, 430), thus forming a magnetic circuit surrounding the movable contact piece (410, 430) at a periphery of the movable contact piece (410, 430) in a width direction D2 thereof. Due to the presence of the first magnetizer 610, most of the magnetic field in the magnetic circuit will gather towards the first magnetizer 610 and magnetize the first magnetizer 610. As a result, an attraction force along a contact pressure direction will be generated between the first magnetizer 610 and the movable contact piece (410, 430) through which the current circulates, and a greater contact pressure will be generated by the attraction force in combination with the contact pressure, and may resist an electro-dynamic repulsion force caused by short-circuit current between the movable contact of the movable contact piece (410, 430) and the static contact of the static contact piece (420, 440), to ensure that the movable contact of the movable contact piece (410, 430) and the static contact of the static contact piece (420, 440) do not pop open.

In addition, the first magnetizer 610 is fixedly connected to the mounting part 11 of the base 10 by the connection portion 611, and does not move along with the push rod mechanism 20, so that the attraction force of the movable contact piece (410, 430) on the first magnetizer 610 acts on the base 10. Due to the relatively fixed position of the base 10, the attraction force of the first magnetizer 610 is independent of the push rod mechanism 20, which may prevent insufficient holding force of the push rod mechanism 20 from causing the movable contact piece (410, 430) and the static contact piece (420, 440) to pop open, resulting in burnout and explosion of the relay.

Further, the first orthographic projection S1 of the connection portion 611 for fixed connection between the first magnetizer 610 and the base 10 on the virtual plane P does not overlap with the second orthographic projection S2 of the movable contact piece (410, 430) on the virtual plane P, that is, the position where the first magnetizer 610 is connected to the base 10 is not located above the movable contact piece (410, 430), so that at least one first magnetizer 610 may be disposed on the base 10, and hence at least one contact assembly 40 corresponds to one first magnetizer 610, which may realize that each contact assembly 40 is provided with the anti-short circuit structure.

As an example, the first magnetizer 610 may be of a flat plate structure. Certainly, in other embodiments, the first magnetizer 610 may also have other regular or irregular shapes.

As shown in FIG. 2, the connection portion 611 is inserted into the mounting part 11 of the base 10 along an insertion direction D4, and the insertion direction D4 is perpendicular to the movement direction D3 of the push rod mechanism 20.

In this embodiment, the connection portion 611 is inserted into the base 10 along the insertion direction D4 perpendicular to the movement direction D3 of the push rod mechanism 20. In case that the first magnetizer 610 is a plate-shaped structure, the first magnetizer 610 is perpendicular to the movement direction D3 of the push rod mechanism 20. In other words, one end of the first magnetizer 610 having the connection portion 611 is connected to the base 10, while the other end of the first magnetizer 610 having the overhang portion 612 extends in an opposite direction of the insertion direction D4 until the overhang portion 612 at least partially overlaps with the movable contact piece (410, 430) in the movement direction D3 of the push rod mechanism 20.

Mounting the first magnetizer 610 on the base 10 by insertion may simplify the assembly process of the first magnetizer 610. Certainly, in other embodiments, the first magnetizer 610 may be connected to the base 10 by adhesive bonding, welding or the like.

Further, the insertion direction D4 of the first magnetizer 610 is perpendicular to the length direction D1 of the movable contact piece (410, 430). That is, in space, the first magnetizer 610 is orthogonal to the movable contact piece (410, 430).

It can be understood that in case that the movable contact piece (410, 430) is energized, the magnetic circuit formed at the periphery of the movable contact piece (410, 430) is along the width of the movable contact piece (410, 430). Since the first magnetizer 610 is orthogonal to the movable contact piece (410, 430), the magnetic circuit will follow the length direction D1 of the overhang portion 612 of the first magnetizer 610, so that a vast majority of the overhang portion 612 is magnetized, further generating a stronger attraction force between the first magnetizer 610 and the movable contact piece (410, 430) through which the current circulates.

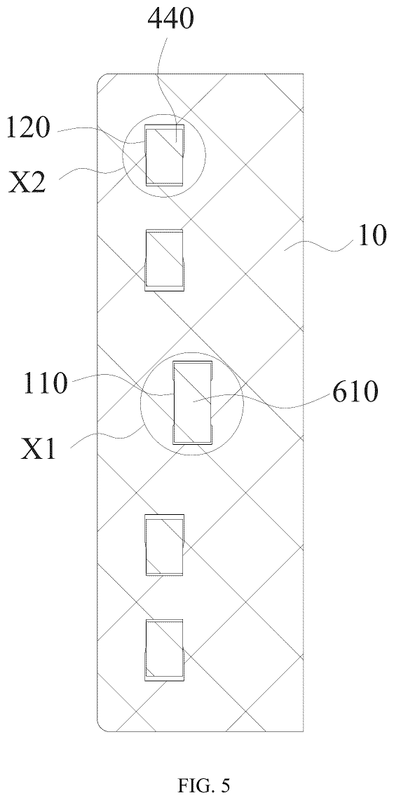

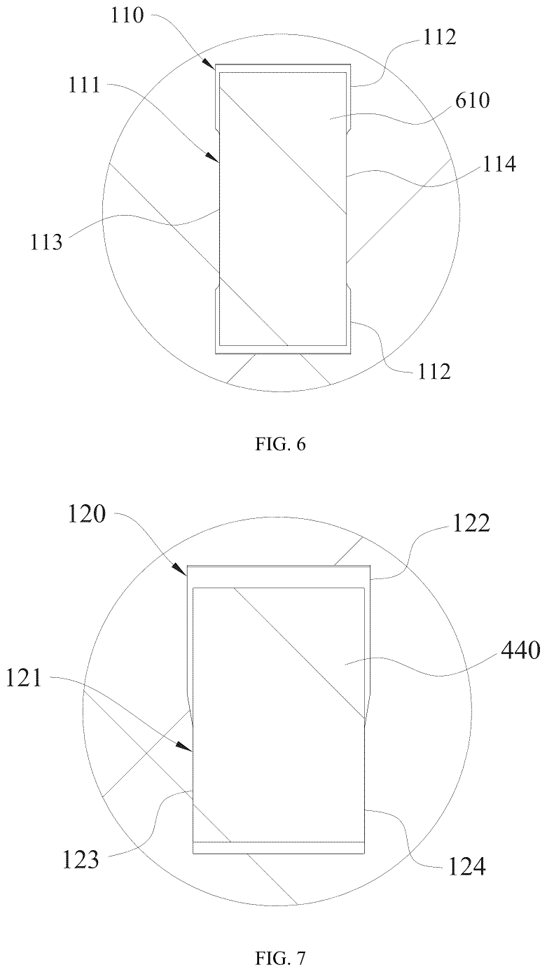

As shown in FIGS. 2, 5, and 6, FIG. 5 shows a sectional view taken along line C-C in FIG. 2; and FIG. 6 shows a partially enlarged view of X1 in FIG. 5. The mounting part 11 includes a first mounting hole 110, which penetrates an inner surface and an outer surface of the housing 1. A hole wall of the first mounting hole 110 has a first positioning wall structure 111 and a first gap wall structure 112. The first magnetizer 610 is inserted into the first mounting hole 110, and a part of an outer wall surface of the first magnetizer 610 abuts against the first positioning wall structure 111. There is a gap between a part of the outer wall surface of the first magnetizer 610 and the first gap wall structure 112, and the gap is filled with a sealant.

In this embodiment, the first mounting hole 110 is formed in the base 10 and penetrates an inner surface and a bottom surface of the base 10.

In the embodiments of the present disclosure, the first magnetizer 610 may be assembled with the base 10 in such a way that, first, preliminary positioning is achieved through the first magnetizer 610 and the first positioning wall structure 111 of the first mounting hole 110 of and the base 10, and then the sealing assembly of the first magnetizer 610 and the base 10 is completed by filling the sealant into the gap between the first magnetizer 610 and the gap wall structure of the first mounting hole 110. On the one hand, a part of the outer wall surface of the first magnetizer 610 abuts against the positioning wall structure 111, thereby achieving preliminary positioning of the first magnetizer 610. On the other hand, there is a gap between a part of the outer wall surface of the first magnetizer 610 and the gap wall structure 112, and by utilizing a siphon effect, the sealant may climb up from the bottom surface side of the base 10 to the inner surface side of the base 10 along the gap until it reaches an opening of the first mounting hole 110, so as to fill the gap with sealant, thereby further enhancing the sealing and positioning strength between the first magnetizer 610 and the base 10. At the same time, the property that the sealant is more resistant to melting than plastic materials is utilized to enhance the welding heat resistance of the relay product. Compared with the related art, the embodiments of the present disclosure reduce an adhesive dispensing step, effectively lowering costs and improving assembly efficiency.

As shown in FIG. 6, the first positioning wall structure 111 includes a first positioning wall 113 and a second positioning wall 114, which are disposed opposite to each other along the movement direction D3 of the push rod mechanism 20. The first positioning wall 113 and the second positioning wall 114 respectively abut against the first magnetizer 610, thereby limiting the degree of freedom of the first magnetizer 610 in the movement direction D3 of the push rod mechanism 20.

It can be understood that shapes of the first positioning wall 113 and the second positioning wall 114 are adapted to an outer contour shape of the first magnetizer 610. For example, in case that a sectional shape of the first magnetizer 610 is rectangular, the first positioning wall 113 and the second positioning wall 114 may be planar. Certainly, in other embodiments, in case that the sectional shape of the connection portion 611 of the first magnetizer 610 is circular, the shapes of the first positioning wall 113 and the second positioning wall 114 may be curved.

A part of the outer wall surface of the first magnetizer 610 is in interference fit with the first positioning wall structure 111. In the embodiments of the present disclosure, the first magnetizer 610 is in interference fit with the first positioning wall 113 and the second positioning wall 114, respectively. Certainly, in other embodiments, a zero-clearance fit may also be used between the part of the outer wall surface of the first magnetizer 610 and the first positioning wall structure 111.

As shown in FIG. 2, the static contact piece (420, 440) is inserted into the base 10 along the insertion direction D4. The static contact piece (420, 440) and the first magnetizer 610 are both inserted into the base 10 along the insertion direction D4, so that the static contact piece (420, 440) and the first magnetizer 610 may be mounted to the base 10 in the same process, which saves assembly time.

As shown in FIGS. 2, 5, and 7, the base 10 also has a second mounting hole 120 that penetrates the inner surface and the bottom surface thereof. A hole wall of the second mounting hole 120 has a second positioning wall structure 121 and a second gap wall structure 122. The static contact piece (420, 440) is inserted into the second mounting hole 120, and a part of an outer wall surface of the static contact piece (420, 440) abuts against the second positioning wall structure 121. There is a gap between a part of the outer wall surface of the static contact piece (420, 440) and the second gap wall structure 122, which is filled with a sealant.

The assembly process of the static contact piece (420, 440) and the base 10 may refer to the assembly process of the first magnetizer 610 and the base 10. That is, the static contact piece (420, 440) and the second positioning wall structure 121 of the second mounting hole 120 first achieve preliminary positioning, and then the gap between the static contact piece (420, 440) and the second gap wall structure 122 is filled with the sealant.

Accordingly, the static contact piece (420, 440) and the first magnetizer 610 may be assembled with the base 10 in the same adhesive dispensing process, which significantly improves assembly efficiency.

The second positioning wall structure 121 includes a third positioning wall 123 and a fourth positioning wall 124, which are disposed opposite to each other along the movement direction D3 of the push rod mechanism 20. The third positioning wall 123 and the fourth positioning wall 124 respectively abut against the static contact piece (420, 440), thereby limiting the degree of freedom of the static contact piece (420, 440) in the movement direction D3 of the push rod mechanism 20.

It can be understood that shapes of the third positioning wall 123 and the fourth positioning wall 124 are adapted to an outer contour shape of a lead-out terminal of the static contact piece. For example, in case that a sectional shape of the lead-out terminal of the static contact piece is rectangular, the third positioning wall 123 and the fourth positioning wall 124 may be planar. Certainly, in other embodiments, in case that the sectional shape of the lead-out terminal of the static contact piece is circular, the shapes of the third positioning wall 123 and the fourth positioning wall 124 may be curved.

A part of the outer wall surface of the static contact piece (420, 440) is in interference fit with the second positioning wall structure 121. In the embodiments of the present disclosure, the part of the outer wall surface of the static contact piece (420, 440) is in interference fit with the third positioning wall 123 and the fourth positioning wall 124, respectively. Certainly, in other embodiments, a zero-clearance fit may also be used between the outer wall surface of the static contact piece (420, 440) and the second positioning wall structure 121.

As previously described, the preliminary positioning of the first magnetizer 610 and the static contact piece (420, 440) is achieved by using a part of the outer wall surface of the first magnetizer 610 to abut against the first positioning wall structure 111 and using the static contact piece (420, 440) to abut against the second positioning wall structure 121 (adhesive dispensing is not required during the preliminary positioning process). Afterwards, adhesive dispensing is carried out from the bottom surface side of the base 10 towards the gap between the first magnetizer 610 and the first gap wall structure 112 and towards the gap between the static contact piece (420, 440) and the second gap wall structure 122. At the same time, adhesive dispensing may also be performed in a clearance between the outer cover and the base 10.

Accordingly, in the embodiments of the present disclosure, adhesive dispensing in the clearance between the first magnetizer 610 and the base 10, the clearance between the static contact piece (420, 440) and the base 10, and the clearance between the outer cover and the base 10 may be realized along one dispensing direction, which significantly improves dispensing efficiency. Certainly, during the dispensing, adhesive dispensing may also be carried out simultaneously in a clearance between a coil lead-out terminal and the base 10, as well as a clearance between an auxiliary contact lead-out terminal and the base 10.

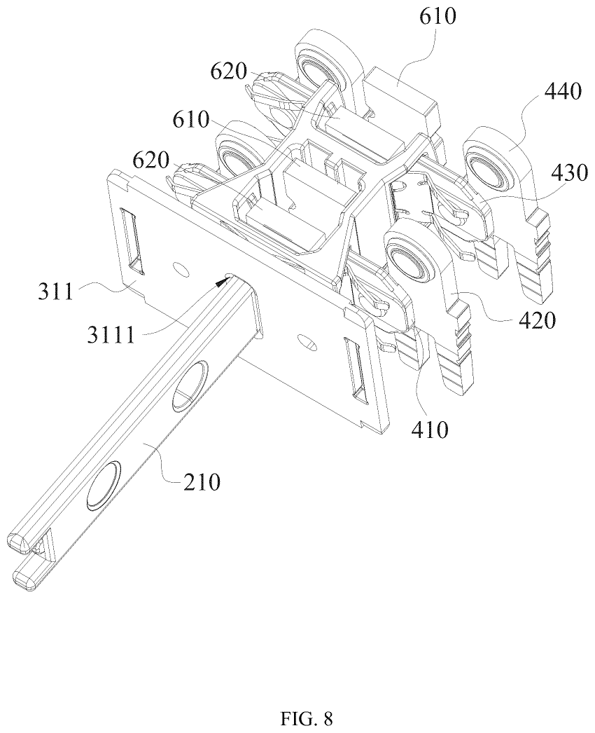

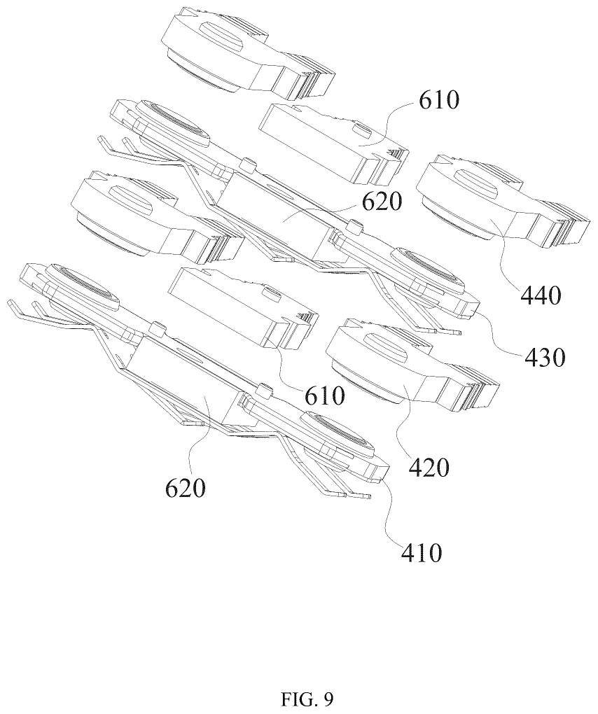

As illustrated in FIGS. 8 and 9, FIG. 8 shows a schematic view after a push rod 210, a yoke plate 311, a first magnetizer 610, a second magnetizer 620, and a contact assembly 40 are assembled according to a first embodiment of the present disclosure; FIG. 9 shows a schematic view after the first magnetizer 610, the second magnetizer 620, and the contact assembly 40 are assembled according to the first embodiment of the present disclosure. The relay further includes at least one second magnetizer 620, which corresponds to at least one first magnetizer 610.

The second magnetizer 620 is fixedly connected to a side of the movable contact piece (410, 430) facing away from the first magnetizer 610, so as to form a magnetic circuit between the first magnetizer 610 and the second magnetizer 620 corresponding to each other and in the width direction D2 of the movable contact piece (410, 430).

It can be understood that at least one second magnetizer 620 corresponds to at least one first magnetizer 610, which means that the number of second magnetizers 620 corresponds to the number of first magnetizers 610, and the positions of the second magnetizers 620 correspond to the positions of the first magnetizers 610. In this embodiment, the number of the first magnetizers 610 is two, and the number of the second magnetizers 620 is also two, but not limited thereto.

In case that two ends of the movable contact piece (410, 430) come into contact with the static contact piece (420, 440), the second magnetizer 620 moving together with the movable contact piece (410, 430) approaches or contacts the first magnetizer 610, thereby forming a magnetic circuit surrounding the movable contact piece (410, 430) between the first magnetizer 610 and the second magnetizer 620. In case that a short-circuit current passes through the movable contact piece (410, 430), an attraction force along a contact pressure direction is generated between the first magnetizer 610 and the second magnetizer 620, and a greater contact pressure is generated by the attraction force in combination with the contact pressure and resists an electro-dynamic repulsion force caused by the short-circuit current between a movable contact of the movable contact piece (410, 430) and a static contact of the static contact piece (420, 440), to ensure that the movable contact of the movable contact piece (410, 430) and the static contact of the static contact piece (420, 440) do not pop open, thereby enhancing the anti-short circuit ability.

It should be noted that the first magnetizer 610 and the second magnetizer 620 are respectively located at both sides of the movable contact piece (410, 430). In case that the movable contact piece (410, 430) is energized, the attraction force between the first magnetizer 610 and the second magnetizer 620 is a direct electromagnetic attraction force, and is greater than the attraction force between the first magnetizer 610 and the movable contact piece (410, 430) in case that the first magnetizer 610 is magnetized alone, such that it may more effectively resist the electro-dynamic repulsion force caused by the short-circuit current between the movable contact piece (410, 430) and the static contact piece (420, 440), thereby effectively enhancing the anti-short circuit ability.

The second magnetizer 620 may be fixedly connected to the movable contact piece (410, 430) by riveting, but not limited thereto.

The first magnetizer 610 and the second magnetizer 620 may be made of materials such as iron, cobalt, nickel, and alloys thereof.

The first magnetizer 610 may be in a straight-line shape, the second magnetizer 620 may be U-shaped, and the second magnetizer 620 wraps around the movable contact piece (410, 430) along the width direction D2 of the movable contact piece (410, 430), but not limited thereto.

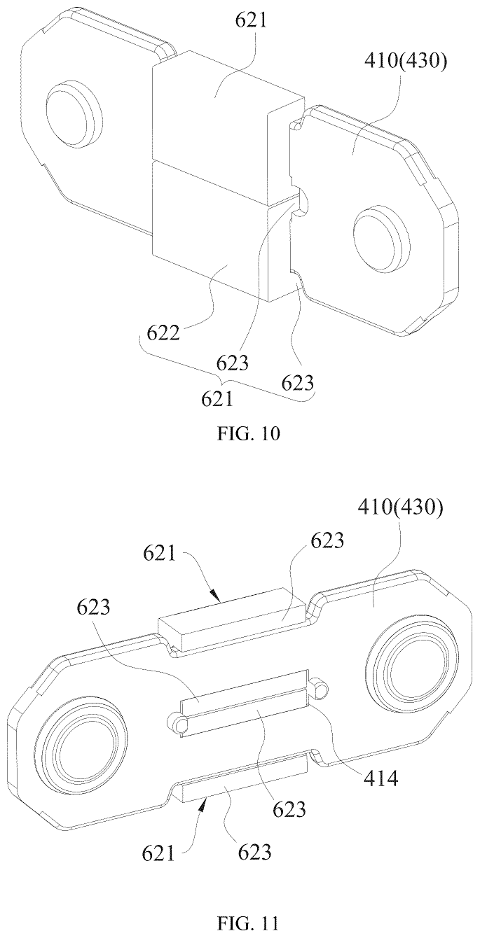

As illustrated in FIGS. 10 and 11, they respectively show schematic views from two different perspectives after a movable contact piece (410, 430) and a second magnetizer 620 are assembled according to a second embodiment of the present disclosure. Similarities between the second embodiment and the first embodiment will not be repeated, and differences are as follows.

The second magnetizer 620 includes at least two sub-magnetizers 621, each of which is U-shaped. Each sub-magnetizer 621 includes a base portion 622 and two side portions 623 connected to the base portion 622. The movable contact piece (410, 430) is provided with at least one through hole 414. The at least two sub-magnetizers 621 are connected to a side of the movable contact piece (410, 430) facing away from the first magnetizer 610, and the side portions 623 of the at least two sub-magnetizers 621 pass through at least one through hole 414, to approach or contact the first magnetizer 610 through the through hole 414, and form at least two independent magnetic circuits in the width direction D2 of the movable contact piece (410, 430). By utilizing at least two independent magnetic circuits to increase a magnetic pole surface at a position corresponding to the through hole 414, in the event of a faulty high current in the movable contact piece (410, 430), an attraction force is generated in the contact pressure direction to resist an electro-dynamic repulsion force generated by the faulty current between the movable contact piece (410, 430) and the static contact piece (420, 440).

The two independent magnetic circuits mean that two magnetic circuits do not interfere with each other, i.e., magnetic fluxes do not cancel each other out.

In this embodiment, the movable contact piece (410, 430) is provided with one through hole 414, which is disposed in a middle area between two movable contacts of the movable contact piece (410, 430). The second magnetizer 620 includes two sub-magnetizers 621, which share one first magnetizer 610 to form two magnetic circuits.

Two U-shaped sub-magnetizers 621 are disposed side by side along the width direction D2 of the movable contact piece (410, 430), and one side portion 623 of each sub-magnetizer 621 passes through the through hole 414 of the movable contact piece (410, 430).

In this embodiment, a top surface of the side portion 623 of each sub-magnetizer 621 is substantially flush with a side surface of the movable contact piece (410, 430) facing the static contact piece (420, 440).

In the embodiments of the present disclosure, the two U-shaped sub-magnetizers 621 have a total of four side portions 623, and top surfaces of the four side portions 623 cooperate with the first magnet 610. Compared with only one magnetic circuit (only two magnetic pole surfaces), on the premise that the structural characteristics of the second magnet 620 keep unchanged, the embodiments of the present disclosure are equivalent to adding two magnetic pole surfaces (equivalent to increasing the magnetic pole surface at the position of the through hole 414), which may improve the magnetic efficiency, increase the attraction force, and greatly enhance the anti-short circuit ability.

There is a gap between two side portions 623 located in one through hole 414. In this way, the magnetic fluxes of the two magnetic circuits will not cancel each other out.

Certainly, in other embodiments, the number of sub-magnetizers 621 may also be three or more.

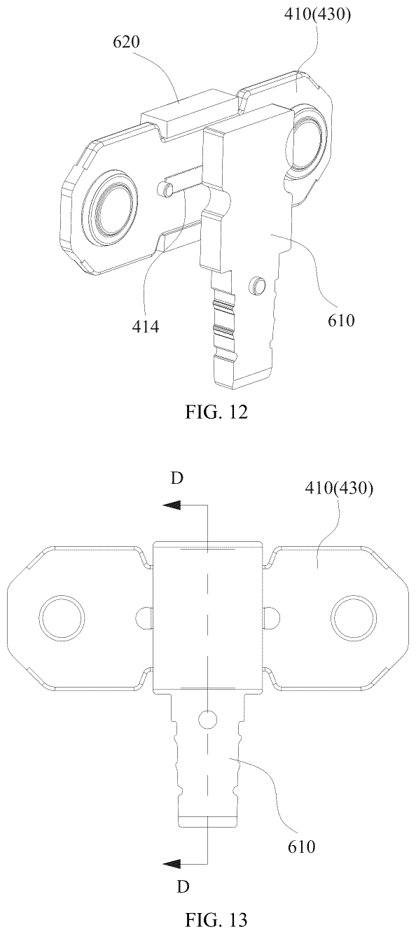

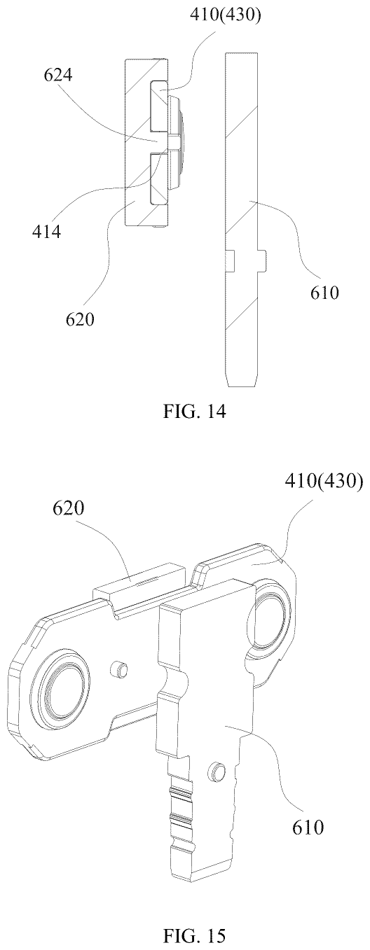

As illustrated in FIGS. 12-14, FIGS. 12 and 13 respectively show schematic views from two different perspectives after a movable contact piece, a first magnetizer, and a second magnetizer are assembled according to a third embodiment of the present disclosure; FIG. 14 shows a sectional view of D-D in FIG. 13. Similarities between the third embodiment and the first embodiment will not be repeated, and differences are as follows.

The movable contact piece (410, 430) is provided with one through hole 414, and the through hole 414 is located in a middle area between two movable contacts of the movable contact piece (410, 430). The second magnetizer 620 is E-shaped and has a middle protrusion 624, and the middle protrusion 624 passes through the through hole 414.

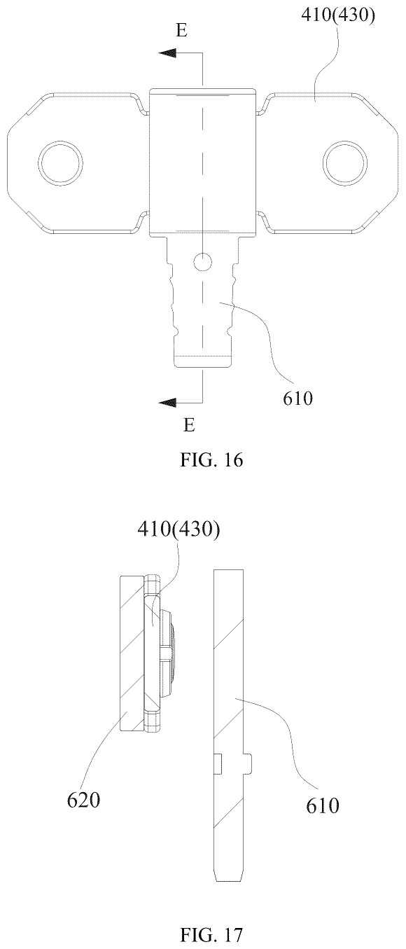

As illustrated in FIGS. 15-17, FIGS. 15 and 16 respectively show schematic views from two different perspectives after a movable contact piece, a first magnetizer, and a second magnetizer are assembled according to a fourth embodiment of the present disclosure; FIG. 17 shows a sectional view of E-E in FIG. 16. Similarities between the fourth embodiment and the first embodiment will not be repeated, and differences are as follows.

The second magnetizer 620 exhibits a straight-line shape.

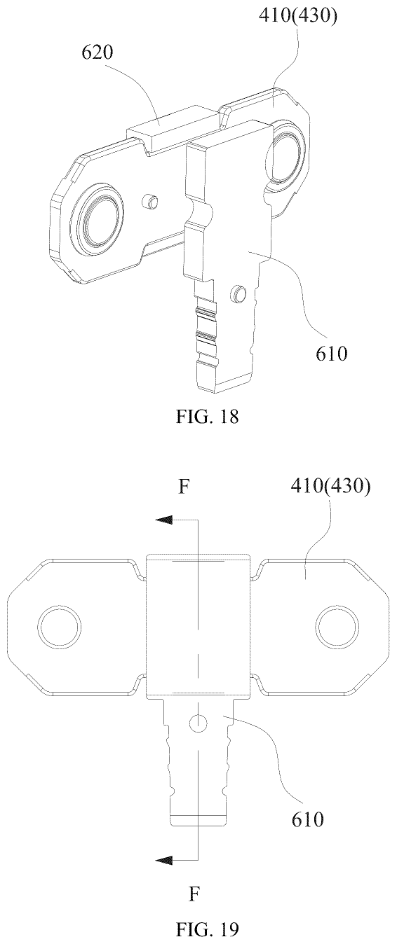

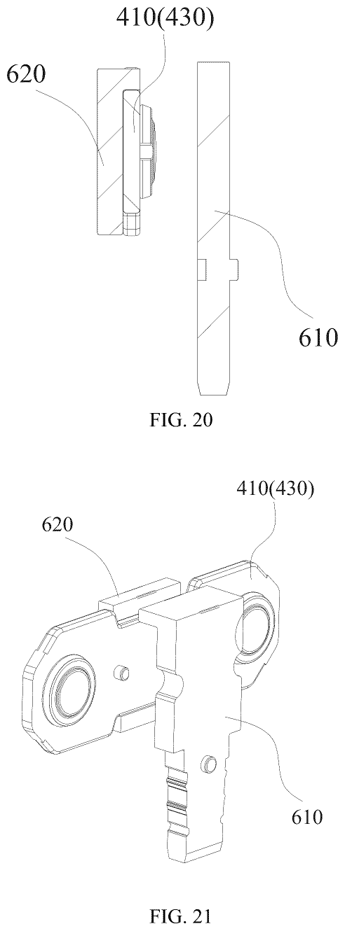

As illustrated in FIGS. 18-20, FIGS. 18 and 19 respectively show schematic views from two different perspectives after a movable contact piece, a first magnetizer, and a second magnetizer are assembled according to a fifth embodiment of the present disclosure; FIG. 20 shows a sectional view of F-F in FIG. 19. Similarities between the fifth embodiment and the first embodiment will not be repeated, and differences are as follows.

The second magnetizer 620 is L-shaped.

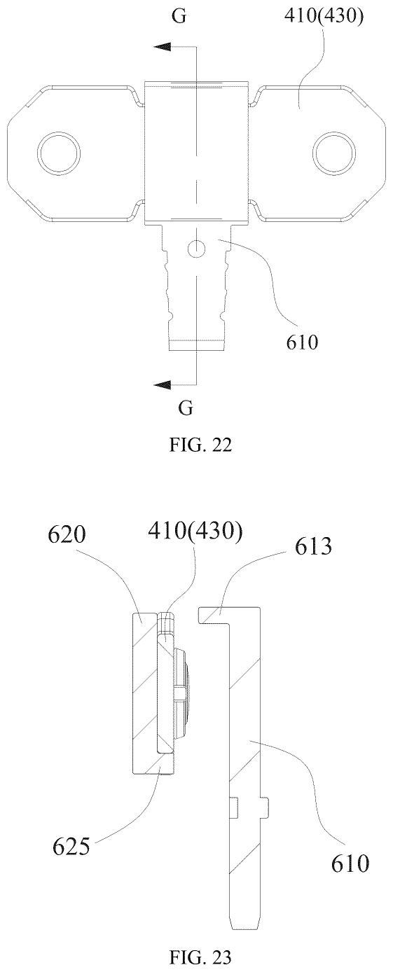

As shown in FIGS. 21-23, FIGS. 21 and 22 respectively show schematic views from two different perspectives after a movable contact piece, a first magnetizer, and a second magnetizer are assembled according to a sixth embodiment of the present disclosure; FIG. 23 shows a sectional view of G-G in FIG. 22. Similarities between the sixth embodiment and the first embodiment will not be repeated, and differences are as follows.

The first magnetizer 610 and the second magnetizer 620 are both L-shaped. The first magnetizer 610 has a first short edge 613, and the second magnetizer 620 has a second short edge 625. The first short edge 613 and the second short edge 625 may or may not correspond to each other.

In this embodiment, the position of the first short edge 613 corresponds to one side of the movable contact piece (410, 430) along the width direction D2, and the position of the second short edge 625 corresponds to the other side of the movable contact piece (410, 430) along the width direction D2.

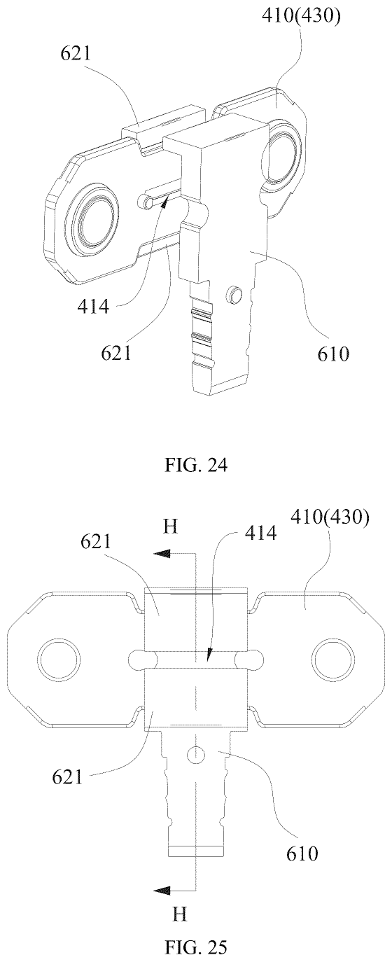

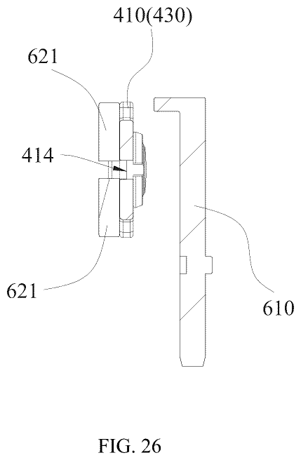

As shown in FIGS. 24-26, FIGS. 24 and 25 respectively show schematic views from two different perspectives after a movable contact piece, a first magnetizer, and a second magnetizer are assembled according to a seventh embodiment of the present disclosure; FIG. 26 shows a sectional view of H-H in FIG. 25. Similarities between the seventh embodiment and the second embodiment will not be repeated, and differences are as follows.

The first magnetizer 610 is L-shaped. The second magnetizer 620 includes two sub-magnetizers 621, and the two sub-magnetizers 621 are in a straight-line shape. The two sub-magnetizers 621 are spaced apart along the width direction D2 of the movable contact piece (410, 430), and the through hole 414 is located between the two sub-magnetizers 621.

For the relay according to embodiments of the present disclosure, since the mounting part on the housing is located at one side of the push rod mechanism in the radial direction that is perpendicular to the movement direction of the push rod mechanism, a position where the first magnetizer is fixedly connected to the mounting part is also located at one side of the push rod mechanism, that is, the position where the first magnetizer is connected to the mounting part of the housing is not above the movable contact piece, so that each first magnetizer will not affect movement of the push rod mechanism in case that the relay is provided with a plurality of first magnetizers. Therefore, the plurality of contact assemblies in the relay according to embodiments of the present disclosure are provided with the plurality of first magnetizers corresponding to the plurality of contact assemblies, which realizes that each contact assembly is provided with an anti-short circuit structure.

It can be understood that various embodiments/implementations provided by the present disclosure may be combined with each other without causing conflicts, and will not be elaborated in detail.

In embodiments of the present disclosure, terms such as “first,” “second,” and “third” are used only for purposes of description and are not intended to indicate or imply relative importance; the term “a plurality of” means two or more than two, unless specified otherwise. Terms such as “mounted,” “connected,” “coupled,” “fixed” and the like should be understood broadly, and may be, for example, fixed connection, detachable connection, or integral connection; may also be direct connection or indirect connection via intervening structures. For those skilled in the art, specific meanings of the above terms in embodiments of the present disclosure may be understood according to specific situations.

In the description of embodiments of the present disclosure, terms such as “upper,” “lower,” “left,” “right,” “front” and “rear” should be construed to refer to the orientations or positions as then described or as shown in the drawings under discussion, and are only used for convenience and simplicity of the description of embodiments of the present disclosure, but do not indicate or imply that the device or unit referred to must have a particular orientation or be constructed and operated in a particular orientation. Thus, these terms shall not be construed as limitation on the embodiments of the present disclosure.

Reference throughout this specification to “an embodiment,” “some embodiments,” “a specific embodiment” and the like means that a particular feature, structure, material, or characteristic described in connection with the embodiment or example is included in at least one embodiment or example of the present disclosure. Thus, the appearances of the phrases throughout this specification are not necessarily referring to the same embodiment or example of the present disclosure. Further, the particular features, structures, materials, or characteristics may be combined in any suitable manner in one or more embodiments or examples.

The above description only involves preferred embodiments of the present disclosure and is not intended to limit embodiments of the present disclosure. For those skilled in the art, embodiments of the present disclosure may have various modifications and variations. Any modifications, equivalent substitutions, and improvements made within the spirit and principles of embodiments of the present disclosure shall be included in the protection scope of embodiments of the present disclosure.

What is claimed is:

1. A relay comprising:
a housing provided with a mounting part;
at least one contact assembly, each contact assembly comprises a static contact piece and a movable contact piece, the static contact piece being fixedly connected to the housing, and the movable contact piece being disposed within the housing;
a push rod mechanism movable relative to the housing along a contact-separation direction of contacts of the contact assembly, wherein the movable contact piece is disposed on the push rod mechanism, and the push rod mechanism is configured to drive the movable contact piece to move, to allow the movable contact piece to contact with or separate from corresponding static contact piece, and wherein the mounting part is located at a side of the push rod mechanism in a radial direction, and the radial direction is perpendicular to a movement direction of the push rod mechanism; and
at least one first magnetizer in one-to-one correspondence with at least one movable contact piece of the at least one contact assembly, the first magnetizer being fixedly connected to the mounting part and located at a side of the movable contact piece facing corresponding static contact piece.

2. The relay according to claim 1, wherein the housing comprises a side wall located at the side of the push rod mechanism in the radial direction, and the mounting part is formed on the side wall.

3. The relay according to claim 2, wherein the side wall surrounds the push rod mechanism along a peripheral direction of the push rod mechanism.

4. The relay according to claim 2, wherein the housing comprises:
a base; and
an outer cover connected to the base, wherein the outer cover and the base form a chamber for accommodating the contact assembly, the push rod mechanism, and the first magnetizer; the base and/or the outer cover form the side wall.

5. The relay according to claim 1, wherein the first magnetizer comprises a connection portion and an overhang portion, and the connection portion is fixedly connected to the mounting part;
a virtual plane perpendicular to the movement direction of the push rod mechanism is defined, the connection portion has a first orthographic projection on the virtual plane, the overhang portion has a second orthographic projection on the virtual plane, the movable contact piece has a third orthographic projection on the virtual plane, the first orthographic projection does not overlap with the third orthographic projection, and the second orthographic projection at least partially overlaps with the third orthographic projection.

6. The relay according to claim 5, wherein the first magnetizer is of a flat plate structure.

7. The relay according to claim 1, wherein the first magnetizer is inserted into the mounting part of the housing along an insertion direction perpendicular to the movement direction of the push rod mechanism.

8. The relay according to claim 7, wherein the mounting part comprises a first mounting hole penetrating an inner surface and an outer surface of the housing, and a hole wall of the first mounting hole having a first positioning wall structure and a first gap wall structure;
the first magnetizer is inserted into the first mounting hole, and a part of an outer wall surface of the first magnetizer abuts against the first positioning wall structure; a gap is formed between a part of the outer wall surface of the first magnetizer and the first gap wall structure, and the gap is filled with a sealant.

9. The relay according to claim 8, wherein a part of the outer wall surface of the first magnetizer is in interference fit with the first positioning wall structure.

10. The relay according to claim 8, wherein the first positioning wall structure comprises a first positioning wall and a second positioning wall, and the first positioning wall and the second positioning wall are disposed opposite to each other along the movement direction of the push rod mechanism.

11. The relay according to claim 7, wherein the insertion direction of the first magnetizer is perpendicular to a length direction of the movable contact piece.

12. The relay according to claim 7, wherein the static contact piece is inserted into the housing along the insertion direction.

13. The relay according to claim 12, wherein the housing further has a second mounting hole penetrating an inner surface and an outer surface of the housing, and a hole wall of the second mounting hole has a second positioning wall structure and a second gap wall structure;
the static contact piece is inserted into the second mounting hole, and a part of an outer wall surface of the static contact piece abuts against the second positioning wall structure; a gap is formed between the outer wall surface of the static contact piece and the second gap wall structure, and the gap is filled with a sealant.

14. The relay according to claim 13, wherein a part of the outer wall surface of the static contact piece is in interference fit with the second positioning wall structure.

15. The relay according to claim 13, wherein the second positioning wall structure comprises a third positioning wall and a fourth positioning wall, and the third positioning wall and the fourth positioning wall are disposed opposite to each other along the movement direction of the push rod mechanism.

16. The relay according to claim 1, further comprising at least one second magnetizer, wherein the at least one second magnetizer corresponds to the at least one first magnetizer;
the second magnetizer is fixedly connected to a side of the movable contact piece facing away from the first magnetizer, to form a magnetic circuit between the first magnetizer and corresponding second magnetizer in a width direction of the movable contact piece.

17. The relay according to claim 16, wherein the second magnetizer is U-shaped and wraps around the movable contact piece along the width direction of the movable contact piece.

18. The relay according to claim 16, wherein the second magnetizer comprises at least two sub-magnetizers, each of the two sub-magnetizers is U-shaped;
the movable contact piece is provided with at least one through hole;
the at least two sub-magnetizers are connected to the side of the movable contact piece facing away from the first magnetizer, and side portions of the at least two sub-magnetizers respectively pass through at least one through hole, to approach or contact the first magnetizer through the through hole and form at least two independent magnetic circuits in the width direction of the movable contact piece.

19. The relay according to claim 18, wherein there is a gap between two side portions located in one through hole.
